(19) United States
(12) Patent Application Publication
(10) Pub. No.: US 2015/0082843 A1
(43) Pub. Date: Mar. 26, 2015

(54) INTEGRATED SEATPOST BICYCLE LOCK

(71) Applicant: Ghostpost, LLC, Humble, TX (US)

(72) Inventor: Matthew Smith, Austin, TX (US)

(73) Assignee: Ghostpost, LLC, Humble, TX (US)

(21) Appl. No.: 14/038,476

(22) Filed: Sep. 26, 2013

(51) Int. Cl. E05B 71/00

(52) U.S. Cl. CPC E05B 71/00
USPC 70/344

(57) ABSTRACT

An integrated seatpost bicycle lock is disclosed. The integrated seatpost lock has four solid members that are pivotally interconnected to form a cylinder seatpost in a first position and a lock in a second position. A first solid member has a lock cylinder end portion having a socket and an opening, and a second solid member has a lock head in one end connected to the opening in the first position and secured into the socket to form the lock in the second position.

### BACKGROUND OF THE INVENTION

Ever since bicycles were introduced in the 19^{th} century, they have gained popularity as a reliable and cost effective means of transportation. It is estimated that there are now more than a billion bicycles worldwide, twice the number of automobiles. There are many types of bicycles available, ranging from recreational bicycles to mountain bicycles, racing bicycles, and other models in between. Bicycles come in different materials depending on their function and are used every day in many places in the world by people of all age groups and social classes.

Bicycle riders everywhere typically consider several factors when choosing a bicycle, including its type, price, color, comfort, gears, how to secure it in place when not in use, and other factors. In particular, securing a bicycle in place requires riders to consider purchasing an additional bicycle lock. Conventional bicycle locks are external devices that lock a bicycle on a fixed object such as a post or rail. There are various types of locks available, including for example, a U-shaped lock and a cable lock. The U-shaped lock is a rigid metal ring in the shape of the letter U, while the cable lock is a cable that can be looped around the bicycle to lock it in place. Both types of locks require the riders to remember to carry them around when riding and can be heavy and cumbersome. Other types of lock exist that are located within or integrated with the bicycle parts, such as locks integrated with the seat, handlebars, or seatpost.

### SUMMARY OF THE INVENTION

An aspect of the invention is directed to an integrated seatpost bicycle lock, comprising: four solid members that are pivotally interconnected to form a cylinder seatpost in a first position and a lock in a second position, wherein: a first solid member comprises a lock cylinder end portion having a socket and an opening, and a second solid member comprises a lock head in one end connected to the opening in the first position and secured into the socket to form the lock in the second position.

Another aspect of the invention is directed to an integrated seatpost bicycle lock, comprising: a first and a third solid member pivotally attached with a first hinge, the first solid member having a lock cylinder end portion; and a second and a fourth solid member pivotally attached with a second hinge, the second solid member having a lock head for connecting to the lock cylinder end portion of the first solid member, and the fourth solid member pivotally attached to the third solid member with a third hinge, wherein the first, second, third, and fourth solid members collapse to form a cylindrical seatpost with the first and third solid members in contact with the first and second solid members along the length thereof, and the first, second, third, and fourth solid members pivot relative to each other to form a lock with the lock head secured into a socket of the lock cylinder end portion.

Furthermore, aspects of the invention may be directed to an integrated seatpost bicycle lock, comprising: a first solid member comprising a first end and a lock cylinder end having a socket and an opening; a second solid member having a first end and a second end, the first end comprising a lock head connected to the opening of the first solid member in a first position and secured into the socket in a second position; a third solid member having a first end pivotally attached to the first end of the first solid member and a second end connected to a seat mounting bracket; and a fourth solid member having a first end pivotally attached to a second end of the third solid member and a second end pivotally attached to the second end of the second solid member.

Additional aspects and advantages of the present disclosure will become readily apparent to those skilled in this art from the following detailed description, wherein only exemplary embodiments of the present disclosure are shown and described, simply by way of illustration of the best mode contemplated for carrying out the present disclosure. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The present application may be more fully appreciated in connection with the following detailed description taken in conjunction with the accompanying drawings, in which like reference characters refer to like parts throughout, and in which:

FIG. 1 illustrates a schematic diagram of an integrated seatpost bicycle lock in a seatpost position in accordance with various examples;

FIG. 2 illustrates how the integrated seatpost lock of FIG. 1 can be placed into a second locking position;

FIG. 3 illustrates a schematic diagram of an integrated seatpost bicycle lock in a locking position in accordance with various examples;

FIG. 4 illustrates an integrated seatpost lock securely attached to a bicycle frame;

FIG. 5 illustrates an example hinge for use in the integrated seatpost lock of FIGS. 1-4;

FIG. 6 is a CAD drawing of an example integrated seatpost lock in a seatpost position; and

FIG. 7 is a CAD drawing of an example integrated seatpost lock in a locking position.

### DETAILED DESCRIPTION OF THE INVENTION

An integrated seatpost bicycle lock is disclosed. The integrated seatpost lock doubles as a seatpost and a lock, thereby avoiding a bicycle rider having to carry a separate lock. As generally described herein, a seatpost refers to a tube that attaches the bicycle frame to the seat. The seatpost is adjustable and can extend out from the bicycle frame to accommodate riders of different heights. In various examples, the integrated seatpost lock is a solid cylindrical tube that can quickly and easily be slid out of the bicycle frame after dismounting and transformed into a secure lock for the bicycle. With the integrated seatpost, riders do not have to carry a separate lock or worry about forgetting the lock as the lock is part of the bicycle itself. The integrated seatpost lock has a very quick and easy to maneuver lock-up process that does not require the use of a key to lock the bicycle in place. In addition to securely locking the bicycle, the integrated seatpost lock can also secure the bicycle seat and prevent it from being stolen.

It is appreciated that, in the following description, numerous specific details are set forth to provide a thorough understanding of the examples. However, it is appreciated that the examples may be practiced without limitation to these specific details. In other instances, well-known methods and structures may not be described in detail to avoid unnecessarily obscuring the description of the examples. Also, the examples may be used in combination with each other.

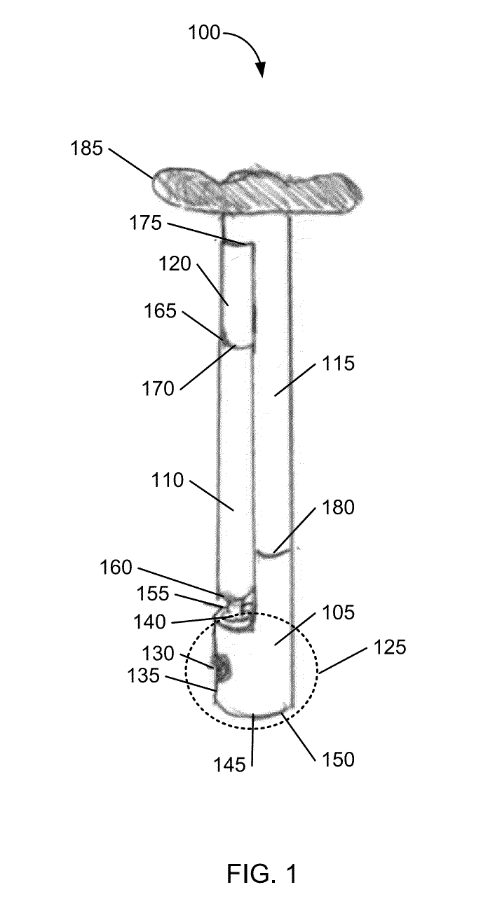

Referring now to FIG. 1, a front view of an integrated seatpost bicycle lock in accordance with various examples is described. Integrated seatpost lock 100 is composed of four solid members that are pivotally interconnected to form a cylinder seatpost in a first position (as shown) and a lock in a second position. The four solid members include a first solid member 105, a second solid member 110, a third solid member 115, and a fourth solid member 120. The first solid member 105 is shown in a reversed L-shape at the bottom of the integrated seatpost 100. First solid member 105 has a lock cylinder end portion 125 with a socket 130 located in outer surface 135 and an opening 140 located at the top of the lock cylinder end portion 125. A keyhole 145 (not visible) is located at bottom surface 150 of lock cylinder end portion 125.

Second solid member 110 is connected to the first solid member 105 by means of a lock head 155. As it can be seen from the figure, lock head 155 is located at one end 160 of second solid member 110 and held in place by opening 140. The other end 165 of second solid member 110 is connected to the fourth solid member 120 via a hinge (not visible) 170. The fourth solid member 120 is also coupled to the third solid member 115 via a hinge (not visible) 175. The third solid member 115 is in turn coupled to the first solid member 105 by means of a hinge (not visible) 180.

The four solid members 105-120 are pivotally interconnected through the three hinges 170-180 in the position shown to form a solid integrated seatpost lock 100 attached to a seat 185 by means of a seat mounting bracket (not shown). Removing the integrated seatpost lock 100 (with or without the seat 185 attached to it) enables a rider to put the integrated seatpost lock 100 into a second locking position.

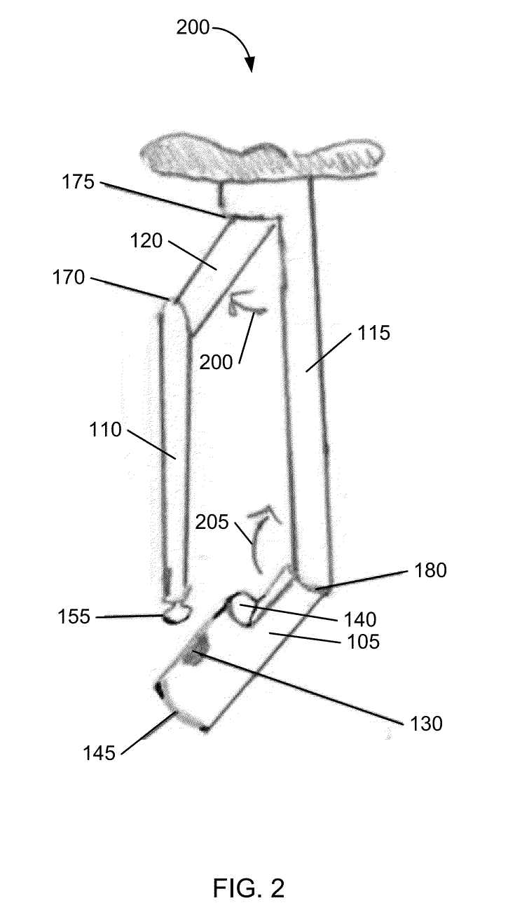

Attention is now directed to FIG. 2, which illustrates how the integrated seatpost lock of FIG. 1 can be placed into the second locking position. A rider simply pivots second solid member 110 and fourth solid member 120 away from first solid member 105 and third solid member 115 at hinges 170-180 to place the integrated seatpost lock 100 into a locking position, as indicated by arrows 200-205. The lock head 155 moves away from opening 140 towards securing it in socket 130. It is noted that the lock head 155 is designed as shown for purposes of illustration only. Other types of lock heads (e.g., cam lock head, combination lock, etc.) and lock mechanisms may be used to secure the integrated seatpost lock 100 into place. For example, a lock head that requires a key for opening may also be used.

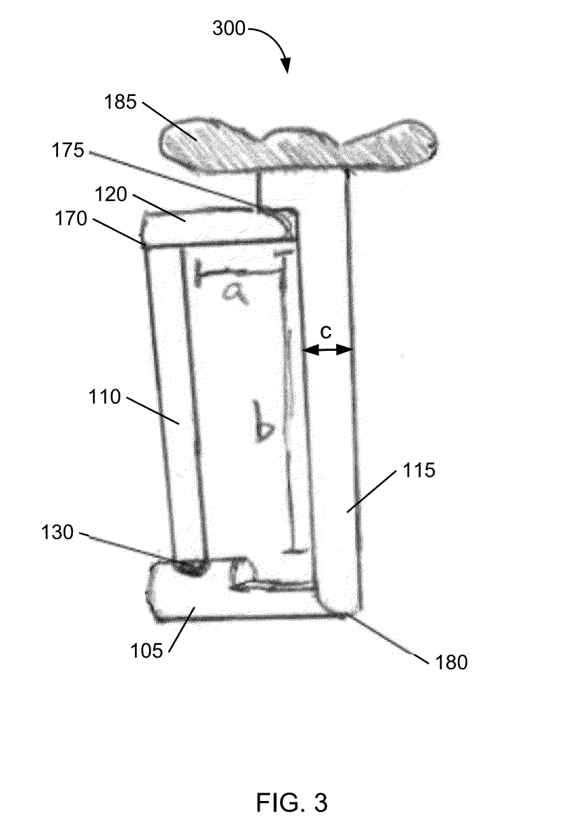

FIG. 3 shows how the lock head 155 is coupled to socket 130 for forming a rectangular lock. It is noted that having a rectangular lock instead of another shape (e.g., triangle) allows for additional locking space and enables bicycle riders to lock their bicycles around larger objects than other shaped locks. In one example, the secure rectangular lock 300 has approximate dimensions of a=4″, b=9″ and c=13 mm to form a secure space of 36 square inches. Other dimensions may be considered as desired. It is also noted that the lock head 155 automatically snaps into socket 130 without the use of a key. Riders simply need to pivot the four solid members 105-120 and connect the lock head 155 into socket 130 to form the secure rectangular lock 300. In other examples, lock head 155 may be designed to connect to the socket 130 with a key or other locking mechanism.

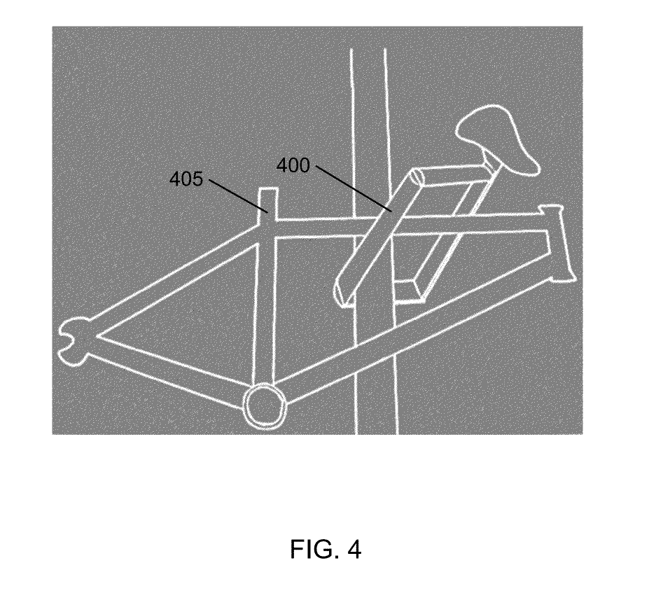

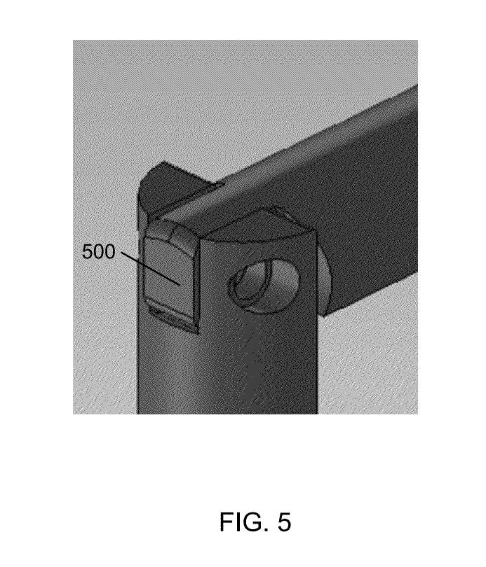

FIG. 4 shows how an integrated seatpost lock 400 can securely attach to a bicycle frame 405. It is noted that hinges 170-180 are very secure and resistant to cutting, sawing, or other breaking means. An example hinge is illustrated in FIG. 5. Hinge 500 is secured with solid pins that have a press fit on their outer parts and a sliding fit on their inner knuckle, allowing for hinge action. The pins can be welded into place on both ends of the hinge and the welds can be ground down to match the rest of the solid cylinder that forms the integrated seatpost lock.

In various examples, the material used to construct the integrated seatpost lock can be selected to provide an optimal combination of weight, strength, cost and appearance, while minimizing the effects of corrosion. Materials can range from titanium, steel or other metal, to hardened plastics, rubber, and so on. The material selected and the design of the integrated seatpost lock enable bicycles to withstand many different kinds of theft attempts (e.g., cutting, sawing, picking, etc.) that are commonly performed on bicycles every day. The only way to open the lock and release the bicycle from its secure position is by using a key inserted into the keyhole 145 at the bottom of solid member 105 (FIG. 1).

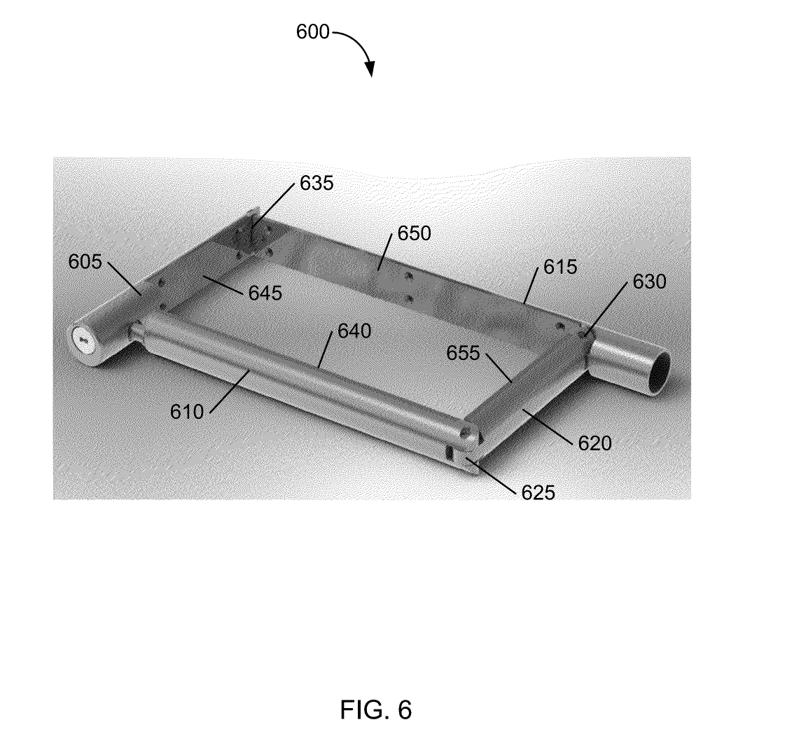

In addition to being secure and effective against bicycle thefts, the integrated seatpost lock described herein is also designed to protect the bicycle frame from any damage arising from contact between the bicycle frame and the lock. Referring now to FIG. 6, a CAD drawing of an example integrated seatpost lock is described. Integrated seatpost lock 600 has four solid members 605-620 that are pivotally interconnected via three hinges 625-635. Each solid member has an inner flat surface and an outer cylindrical surface. The inner flat surfaces are coated or bonded with a protection material (e.g., nylon, plastic, rubber, etc.) to protect the bicycle frame from scratches or other damage that may be incurred by contact with the integrated seatpost lock. The protection material that is added to the inner flat surfaces of solid members 605-620 forms a protective layer 640-655 in each solid member that is kept very thin (e.g., 1-2 mm) and accounts for the overall diameter of the integrated seatpost lock.

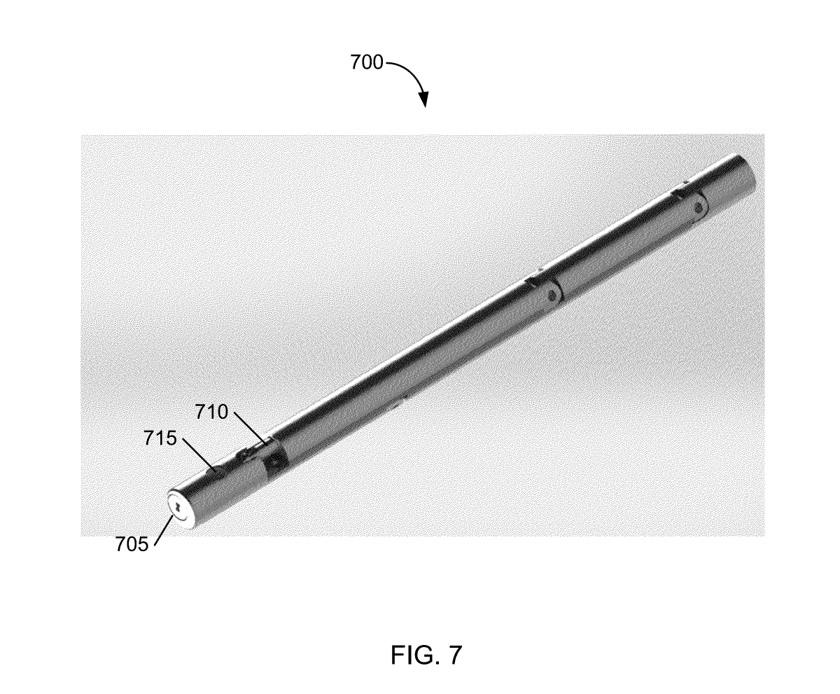

The integrated seatpost lock is shown in its collapsed seatpost position in FIG. 7. Integrated seatpost lock 700 is a solid cylindrical seatpost that is identical in size (e.g., 27.18 mm in diameter) and shape to conventional cylindrical seatposts. The thickness of the protective layer in the inner flat surfaces of the solid members is included in the overall size and dimension of the integrated seatpost lock. The integrated seatpost lock can slide into and out of a bicycle seat tube easily, while still being a snug fit when used as a seatpost. It is noted that keyhole 705 now visible in integrated seatpost lock 700 is used only to unlock the integrated seatpost lock 700 from its locking position. The integrated seatpost lock 700 can be transformed into its locking position by pivoting the solid members relative to each other and automatically securing the lock head 710 into socket 715. All solid members are visible to the rider; there are no hidden members that need to be used to transform the integrated seatpost lock into a locking position.

It is appreciated that the previous description of the disclosed examples is provided to enable any person skilled in the art to make or use the present disclosure. Various modifications to these examples may be readily apparent to those skilled in the art, and the generic principles defined herein may be applied to other examples without departing from the spirit or scope of the disclosure. The present disclosure is thus not intended to be limited to the examples shown herein but is to be accorded the widest scope consistent with the principles and novel features disclosed herein.

What is claimed is:

1. An integrated seatpost bicycle lock, comprising:
four solid members that are pivotally interconnected to form a cylinder seatpost in a first position and a lock in a second position, wherein:
a first solid member comprises a lock cylinder end portion having a socket and an opening, and
a second solid member comprises a lock head in one end connected to the opening in the first position and secured into the socket to form the lock in the second position.

2. The integrated seatpost bicycle lock of claim 1, wherein the four solid members pivot relative to each other on three hinges to form the lock in the second position.

3. The integrated seatpost bicycle lock of claim 1, wherein the lock is secured automatically without using a key.

4. The integrated seatpost bicycle lock of claim 1, wherein the first solid member is pivotally attached to a first end of a third solid member by a first hinge.

5. The integrated seatpost bicycle lock of claim 4, wherein the third solid member has a second end to connect to a bicycle seat mounting bracket.

6. The integrated seatpost bicycle lock of claim 5, wherein the second solid member is pivotally attached to a first end of a fourth solid member by a second hinge.

7. The integrated seatpost bicycle lock of claim 5, wherein the fourth solid member is pivotally attached to the second end of the third solid member by a third hinge.

8. The integrated seatpost bicycle lock of claim 1, wherein the lock cylinder end portion comprises a keyhole at a bottom surface for inserting a key to open the lock.

9. The integrated seatpost bicycle lock of claim 1, wherein the four solid members comprise inner flat surfaces and outer cylindrical surfaces.

10. The integrated seatpost bicycle lock of claim 9, wherein the inner flat surfaces are coated with a protection material.

11. An integrated seatpost bicycle lock, comprising:
a first and a third solid member pivotally attached with a first hinge, the first solid member having a lock cylinder end portion; and
a second and a fourth solid member pivotally attached with a second hinge, the second solid member having a lock head for connecting to the lock cylinder end portion of the first solid member, and the fourth solid member pivotally attached to the third solid member with a third hinge, wherein
the first, second, third, and fourth solid members collapse to form a cylindrical seatpost with the first and third solid members in contact with the first and second solid members along the length thereof, and
the first, second, third, and fourth solid members pivot relative to each other to form a lock with the lock head secured into a socket of the lock cylinder end portion.

12. The integrated seatpost bicycle lock of claim 11, wherein the first, second, third, and fourth solid members are made of a material from the group consisting of steel, titanium, aluminum, Kevlar, plastic, hardened rubber and polymer.

13. The integrated seatpost bicycle lock of claim 11, wherein the first and second solid members become in contact with the third and fourth solid members via flat inner surfaces.

14. The integrated seatpost bicycle lock of claim 13, wherein the flat inner surfaces are bonded with a protection material.

15. The integrated seatpost bicycle lock of claim 14, wherein the protection material comprises one from the group consisting of nylon, plastic and rubber.

16. The integrated seatpost bicycle lock of claim 11, wherein the lock cylinder end portion comprises a keyhole at a bottom surface for inserting a key to open the lock.

17. The integrated seatpost bicycle lock of claim 16, wherein the lock head secured into the socket forms an automatic lock without a key.

18. An integrated seatpost bicycle lock, comprising:
a first solid member comprising a first end and a lock cylinder end having a socket and an opening;
a second solid member having a first end and a second end, the first end comprising a lock head connected to the opening of the first solid member in a first position and secured into the socket in a second position;
a third solid member having a first end pivotally attached to the first end of the first solid member and a second end connected to a seat mounting bracket; and
a fourth solid member having a first end pivotally attached to a second end of the third solid member and a second end pivotally attached to the second end of the second solid member.

19. The integrated seatpost bicycle lock of claim 18, wherein the first and third solid members pivot away from the second and fourth solid members to form a rectangular lock, the rectangular lock secured into place automatically by having the lock head snap into the socket.

20. The integrated seatpost bicycle lock of claim 19, wherein the lock cylinder end portion comprises a keyhole at a bottom surface for opening the lock with a key.
